(19) United States
(12) Patent Application Publication
(10) Pub. No.: US 2006/0171629 A1
(43) Pub. Date: Aug. 3, 2006

(54) Method for removing cross-talk in wavelength division multiplexed passive optical network

(75) Inventors: Dong-Jae Shin, Suwon-si (KR); Chang-Sup Shim, Seoul (KR); Seong-Taek Hwang, Pyeongtaek-si (KR); Dae-Kwang Jung, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/341,727

(22) Filed: Jan. 27, 2006

(30) Foreign Application Priority Data
Feb. 1, 2005 (KR) 9101/2005

(51) Int. Cl. G02B 6/28

(52) U.S. Cl. 385/24

(57) ABSTRACT

Disclosed is a method for removing cross-talk in a wavelength division multiplexed passive optical network (WDM-PON). The WDM-PON and the method remove cross-talk between adjacent wavelength channels due to incomplete alignment of wavelength channels in a MUX/de-MUX between a central office and a remote node in the WDM-PON employing light-injected light sources. The WDM-PON includes at least two broadband light sources having different bands, which provide injection light to be injected to light-injected channels light sources, a transmitter receiving injection from the broadband light sources, injecting the injection light to odd channel light-injected light sources and even channel light-injected light sources, arraying odd and even channels in such a manner that the odd and even channels belong to different spectrum bands, multiplexing the signal according channels, and transmitting the multiplexed signal. The WDM-PON may also include a receiver for receiving the multiplexed signal transmitted from the transmitter and splitting the multiplexed signal according to the odd and even channels.

### CLAIM OF PRIORITY

This application claims the benefit of the earlier filing date of that patent application entitled “Wavelength Division Multiplexed Passive Optical Network (WDM-PON) without Cross-Talk and Method for Removing Cross-talk” filed in the Korean Intellectual Property Office on Feb. 1, 2005, and assigned Serial No. 2005-9101, the contents of which are incorporated herein by reference.

### BACKGROUND OF THE INVENTION

1. Field of the Invention

The present invention relates to a wavelength division multiplexed passive optical network (WDM-PON), and more particularly to a wavelength division multiplexed passive optical network with reduced cross-talk between adjacent wavelengths.

2. Description of the Related Art

With increasing interest in a wavelength division multiplexed passive optical network (WDM-PON) as a next generation optical network for providing a future broadband communication service, efforts for economical realization of the WDM-PON are presently being undertaken.

Since such a WDM-PON allocates an individual wavelength to each subscriber, it is necessary to employ WDM light sources for subscribers and a multiplexer/de-multiplexer (MUX/de-MUX) to process the plurality of wavelength channels generated from the WDM light sources. The economical realization of wavelength alignment between the WDM light sources and the MUX/de-MUX is an important factor of reducing maintenance costs of a WDM-PON network.

Generally, light sources such as a distributed feedback laser array, a high-power light emitting diode, or a spectrum-sliced source are suggested as the WDM light sources. However, recently, light-injected light sources such as an external light-injected Fabry-Perot laser diode (FP-LD) or a wavelength-seeded reflective semiconductor amplifier, which have wavelengths determined by externally injected light have been suggested.

Since these light-injected light sources have wavelengths determined by externally injected light, one type of a light source may be used for a plurality of wavelength channels without additional control. Accordingly, it is unnecessary to align wavelengths between the light source and a MUX/de-MUX, so it is possible to maintain and operate a network in a simple manner.

The typical WDM-PON has several advantages such as having a large bandwidth, superior security, and protocol independence. However, since the typical WDM-PON requires a plurality of light sources, device costs increase. In addition, since the typical WDM-PON employs a MUX/de-MUX in order to multiplex a plurality of wavelength channels into one transmitted signal and demultiplex the transmitted signal into a plurality wavelength channels, the WDM-PON is susceptible to adjacent wavelength channel cross-talk.

In particular, the WDM-PON employing light-injected light sources may have cross-talk due to adjacent wavelength channels when wavelength channels multiplexed/de-multiplexed in a MUX/D-MUX between a central office and a remote node are incompletely aligned.

### SUMMARY OF THE INVENTION

Accordingly, the present invention has been made to solve the above-mentioned problems occurring in the prior art and provides additional advantages, by providing a wavelength division multiplexed passive optical network having no cross-talk by removing cross-talk between adjacent wavelength channels due to incomplete alignment of wavelength channels in a MUX/de-MUX.

According to one aspect of the present invention, there is provided a wavelength division multiplexed passive optical network (WDM-PON) employing a light-injected light source without cross-talk, which includes at least two broadband light sources having different spectrum bands, which provide injection light to be injected to light-injected channel light sources, a transmitter receiving injection light having different bands from the broadband light sources, injecting the injection light to odd channel light-injected light sources and even channel light-injected light sources, aligning odd and even channels such that the odd and even channels belong to different spectrum bands, multiplexing the signal channels and transmitting the multiplexed signal. Also included is a receiver for receiving the multiplexed signal transmitted from the transmitter and splitting the multiplexed signal according to the respective channels.

According to another aspect of the present invention, there is provided a method for removing cross-talk in a wavelength division multiplexed passive optical network employing a light-injected light source, the method including the steps of providing at least two broadband light sources having different spectrum bands, the two broadband light sources provide injection light to be injected to light-injected channel light sources, receiving the injection light from the broadband light sources, injecting the injection light to odd channel light-injected light sources and even channel light-injected light sources, aligning the odd and even channels such that the odd and even channels belong to different spectrum bands, multiplexing the channels, transmitting the multiplexed signal and receiving the transmitted multiplexed signal and splitting the transmitted multiplexed signal according to the respective channels.

### BRIEF DESCRIPTION OF THE DRAWINGS

The above features and advantages of the present invention will be more apparent from the following detailed description taken in conjunction with the accompanying drawings, in which:

FIGS. 1A and 1B are block diagrams illustrating an upstream transmission structure of a WDM-PON using external light-injected light sources according to an embodiment of the present invention;

FIGS. 2A and 2B are block diagrams illustrating a downstream transmission structure of a WDM-PON using external light-injected light sources according to an embodiment of the present invention;

FIGS. 3A and 3B are block diagrams illustrating an upstream and downstream transmission structure of a WDM-PON using externally light-injected light sources according to an embodiment of the present invention; and

FIG. 4 is a block diagram illustrating the structure of a bi-directional transceiver shown in FIG. 3A.

### DETAILED DESCRIPTION

Hereinafter, an embodiment of the present invention will be described in detail with reference to the accompanying drawings. Note that the same or similar components in drawings are designated by the same reference numerals as far as possible although they are shown in different drawings. For the purposes of clarity and simplicity, a detailed description of known functions and configurations incorporated herein will be omitted as it may make the subject matter of the present invention unclear.

The present invention relates to a structure for removing cross-talk between neighboring or adjacent channels due to an incomplete wavelength alignment of a MUX/de-MUX between a central office and a remote node in a wavelength division multiplexed passive optical network (WDM-PON) using a light-injected light source (e.g. a light-injected Fabry-Perot laser or a wavelength-seeded reflective semiconductor optical amplifier).

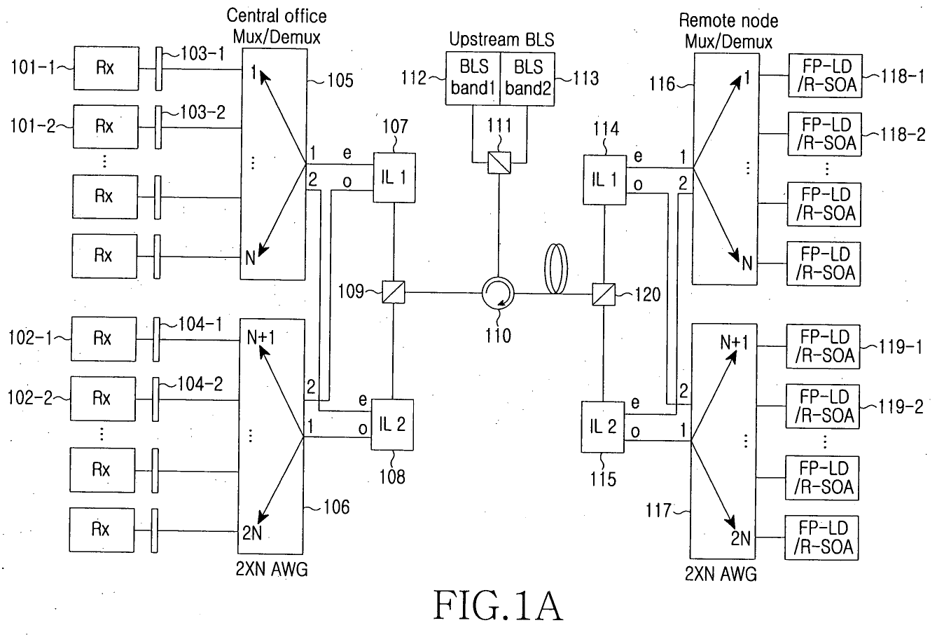

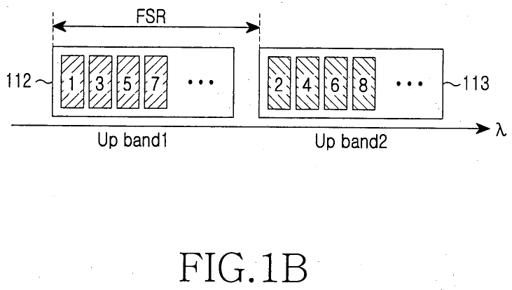

FIG. 1A is a block diagram illustrating an upstream transmission structure of a WDM-PON using external light-injected light sources according to an embodiment of the present invention.

As shown in FIG. 1A, the WDM-PON employs a structure using two wavelength bands separated from each other (mutually exclusive) by a free spectral range (FSR) in a multiplexer/de-multiplexer (MUX/de-MUX) used for a central office and a remote node.

Light-injected upstream light sources include a first broadband light source 112 having a first band and a second broadband light source 113 having a second band.

In the procedure of injecting light for the purpose of employing broadband light sources as upstream light sources, an injection light having a wide line-width generated from the first broadband light source 112 is delivered to a second interleaver 115 from a first WDM filter 120 through a circulator 110 and a transmission optical fiber. In this case, interleavers 107, 108, 114, and 115 are elements for outputting an input light through two output ports by splitting the input light into odd channels and even channels. The interleavers 107, 108, 114, and 115 employed according to an embodiment of the present invention operate based on channels identical to those of MUXs/de-MUXs 105, 106, 116, and 117. In addition, the MUXs/de-MUXs 105, 106, 116, and 117 employed according to an embodiment of the present invention have two input/output ports at one side of the MUXs/de-MUXs 105, 106, 116, and 117 in the 2×N shapes.

In addition, injection light output to an even port of the second interleaver 115 is divided into channels according to its wavelength(s) and output in the first MUX/de-MUX 116 connected to the second interleaver 115. Since the injection light is input to the second port of the first MUX/de-MUX 116, the injection light is output as odd channels and input as injection light to a light-injected light source of the odd channels. The light-injected light sources include, for example, a Fabry-Perot laser or a reflective semiconductor optical amplifier.

In the meantime, injection light output to an odd port of the second interleaver 115 is divided into channels according to its wavelength(s) and output in the second MUX/de-MUX 117 connected to the second interleaver 115. Since the injection light is input to the first port of the second MUX/de-MUX 117, the injection light is output as odd channels and input as injection light to a light-injected light source of the odd channels. The light-injected light sources include a Fabry-Perot laser or a reflective semiconductor optical amplifier, for example.

In other words, the first broadband light source 112 having the first band fixes the wavelengths of odd channels 118-1 and 119-1 which are spectrum-split in the MUX/de-MUXs 116 and 117, respectively.

Similarly, injection light having a wide line-width generated from the second light source 113 occupying a separate second band is output to even and odd ports of the first interleaver 114, output according to channels in the MUX/de-MUX 116 and 117, and input as injection light to a light-injected light source for even channels. Herein, the light-injected light sources include a Fabry-Perot laser or a reflective semiconductor optical amplifier, for example.

In other words, the second broadband light source 113 having a second band fixes the wavelengths of even channels 118-2 and 119-2 which are spectrum-split in the MUX/de-MUXs 116 and 117, respectively.

Through the above-described scheme, 2×N wavelength channels are arrayed by interleaving the first-band wavelength as odd channels and the second-band wavelength as even channels.

The wavelength channels arrayed as described above are output from the Fabry-Perot laser or the reflective semiconductor optical amplifier, progress in a reverse direction, are multiplexed in the first WDM filter 120, and then are transmitted to the central office through a transmission optical fiber. Wavelength channels are de-multiplexed and input in receivers while undergoing the same scheme in the second WDM filter 109.

A multiplexed upstream optical signal having the injection light of the first broadband light source 112 is delivered to the third interleaver 108 from the second WDM filter 109 through a transmission optical fiber.

An upstream optical signal output to an even port of the third interleaver 108 is divided into channels according to its wavelength(s) and output in the fourth MUX/de-MUX 105 connected to the third interleaver 108. However, since the upstream optical signal is input to the second port of the fourth MUX/de-MUX 105, the upstream optical signal is output as odd channels and input to an optical receiver 101-1 of the odd channels. In this case, a first bandpass filter 103-1 passing the first band wavelength is installed at a front side of the optical receiver 101-1 so as to prevent cross-talk.

In addition, an upstream optical signal output through an odd port of the third interleaver 108 is divided into channels according to its wavelength(s) and output in the third MUX/de-MUX 106 connected to the third interleaver 108. Since the upstream optical signal is input to the first port of the third MUX/de-MUX 106, the upstream optical signal is output as odd channels and input to an optical receiver 102-1 of the odd channels. In this case, a first bandpass filter 104-1 passing the first band wavelength is installed at a front side of the optical receiver 102-1 to prevent cross-talk.

Meanwhile, an upstream optical signal output through an odd port of the fourth interleaver 107 is divided into channels according to its wavelength(s) and output in the third MUX/de-MUX 106 connected to the fourth interleaver 107. Since the upstream optical signal is input to the second port of the third MUX/de-MUX 106, the upstream optical signal is output as even channels and input to an optical receiver 102-2 of the even channels. In this case, a second bandpass filter 104-2 passing the second band wavelength is installed at a front side of the optical receiver 102-2 to prevent cross-talk.

Furthermore, an upstream optical signal output to an even port of the fourth interleaver 107 is divided into channels according to its wavelength(s) and output in the fourth MUX/de-MUX 105 connected to the fourth interleaver 107. Since the upstream optical signal is input to the first port of the fourth MUX/de-MUX 105, the upstream optical signal is output as even channels and input to an optical receiver 101-2 of the even channels. In this case, a second bandpass filter 103-2 passing the second band wavelength is installed at a front side of the optical receiver 101-2 so as to prevent cross-talk.

As described above, it is possible to efficiently prevent cross-talk due to optical signals of adjacent channels by fixing the wavelengths of adjacent channels using injection light having different bands. In other words, even though channels are adjacent to each other, wavelengths of adjacent channels belong to mutually exclusive wavelength bands. Accordingly, even though wavelengths are incompletely aligned in a MUX/de-MUX, it is possible to prevent light of the adjacent channels from being received in receivers by employing bandpass filters.

FIG. 1B illustrates broadband light sources having mutually different bands in an upstream transmission structure of the WDM-PON using an external light-injected light source according to an embodiment of the present invention.

As shown in FIG. 1B, the spectral band of light source 112 (first band) and the spectral band of light source 113 (second band) are separated from each other by a free spectral range (FSR). The first band and the second band include odd channel upstream signals and even channel upstream signals, respectively.

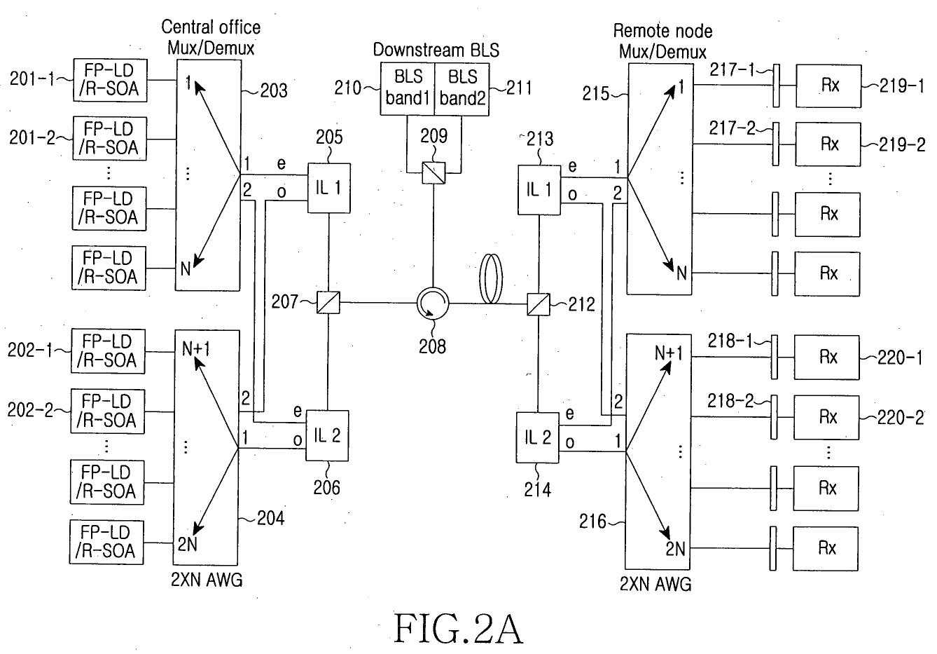

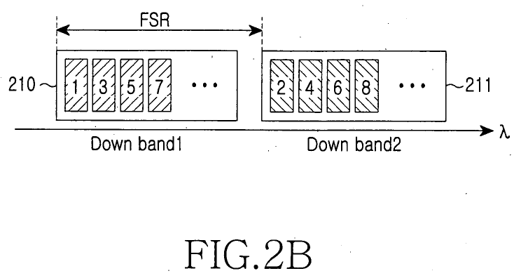

FIG. 2A is a block diagram illustrating a downstream transmission structure of the WDM-PON using external light-injected light sources according to an embodiment of the present invention.

The WDM-PON shown employs a structure using two wavelength bands separated from each other by a free spectral range (FSR) in a multiplexer/de-multiplexer (MUX/de-MUX) used for a central office and a remote node.

Light sources for injecting downstream light include a first broadband light source 210 having a first band and a second broadband light source 211 having a second band.

In the procedure of injecting light for the purpose of employing broadband light sources as downstream light sources, injection light having a wide line-width generated from the first broadband light source 210 is delivered to a second interleaver 206 from a first WDM filter 207 through a circulator 208. In this case, interleavers 205, 206, 213, and 214 are elements for outputting an input light through two output ports by splitting the input light into odd channels and even channels. The interleavers 205, 206, 213, and 214 employed according to an embodiment of the present invention operate based on channels substantially identical to channels of MUXs/de-MUXs 203, 204, 215, and 216. In addition, the MUXs/de-MUXs 203, 204, 215, and 216 employed according to this embodiment of the present invention have two input/output ports at one side of the MUXs/de-MUXs 203, 204, 215, and 216 in the 2×N shape.

In addition, injection light output to an even port of the second interleaver 206 is divided into channels according to its wavelength(s) and output in the first MUX/DE-MUX 203 connected to the second interleaver 206. Since the injection light is input to the second port of the first MUX/de-MUX 203, the injection light is output as odd channels and input as injection light to a light-injected light source 201-1 of the odd channels. The light-injected light sources may include a Fabry-Perot laser or a reflective semiconductor optical amplifier, for example.

The injection light output to an odd port of the second interleaver 206 is divided into channels according to its wavelength(s) and output in the second MUX/de-MUX 204 connected to the second interleaver 206. Since the injection light is input to the first port of the second MUX/de-MUX 204, the injection light is output as odd channels and input as injection light to a light-injected light source 202-1 of the odd channels. The light-injected light sources include a Fabry-Perot laser or a reflective semiconductor optical amplifier.

In other words, the first broadband light source 210 having the first band fixes the wavelengths of odd channels 201-1 and 202-1 spectrum-split in the MUX/de-MUXs 203 and 204, respectively.

Similarly, injection light having a wide line-width generated from the second light source 211 having the second band is output to even and odd ports of the first interleaver 205, output according to channels in the MUX/de-MUX 203 and 204, and input to light-injected light sources 201-2 and 202-2 for even channels as injection light. Herein, the light-injected light sources may include a Fabry-Perot laser or a reflective semiconductor optical amplifier, for example.

In other words, the second broadband light source 211 having the second band fixes the wavelengths of even channels 201-2 and 202-2 spectrum-split in the MUX/de-MUXs 203 and 204, respectively.

Through the above-described scheme, 2×N wavelength channels are aligned by interleaving the first-band wavelength including odd channels and the second-band wavelength including even channels.

The wavelength channels aligned as described above are output from the Fabry-Perot laser or the reflective semiconductor optical amplifier, progress in a reverse direction, are multiplexed in the first WDM filter 207, and then are transmitted to the remote node through a transmission optical fiber. The wavelength channels are de-multiplexed and input to receivers 219-1, 219-2, 220-1, and 220-1 while undergoing the same scheme in the second WDM filter 212.

A multiplexed downstream optical signal having the injection light of the first broadband light source 210 is delivered to the third interleaver 214 from the second WDM filter 212 through a transmission optical fiber.

In addition, a downstream optical signal output to an even port of the third interleaver 214 is divided into channels according to its wavelength(s) and output in the fourth MUX/DE-MUX 215 connected to the third interleaver 214. Since the downstream optical signal is input to the second port of the fourth MUX/DE-MUX 215, the downstream optical signal is output as odd channels and input to an optical receiver 219-1 of the odd channels. In this case, a first bandpass filter 217-1 passing the first band wavelengths is installed at a front side of the optical receiver 219-1 so as to prevent cross-talk.

In addition, a downstream optical signal output through an odd port of the third interleaver 214 is divided into channels according to its wavelength(s) and output in the third MUX/de-MUX 216 connected to the third interleaver 214. Since the downstream optical signal is input to the first port of the third MUX/de-MUX 216, the downstream optical signal is output as odd channels and input to an optical receiver 220-1 of the odd channels. In this case, a first bandpass filter 218-1 passing the first band wavelengths is installed at a front side of the optical receiver 220-1 to prevent cross-talk.

Meanwhile, a downstream optical signal output through an odd port of the fourth interleaver 213 is divided into channels according to its wavelength(s) and output in the third MUX/de-MUX 216 connected to the fourth interleaver 213. However, since the downstream optical signal is input to the second port of the third MUX/de-MUX 216, the downstream optical signal is output as even channels and input to an optical receiver 220-2 of the even channels. In this case, a second bandpass filter 218-2 passing the second band wavelengths is installed at a front side of the optical receiver 220-2 so as to prevent cross-talk.

Furthermore, a downstream optical signal output to an even port of the fourth interleaver 213 is divided into channels according to its wavelength(s) and output in the fourth MUX/de-MUX 215 connected to the fourth interleaver 213. Since the downstream optical signal is input to the first port of the fourth MUX/de-MUX 215, the downstream optical signal is output as even channels and input to an optical receiver 219-2 of the even channels. In this case, a second bandpass filter 217-2 passing the second band wavelengths is installed at a front side of the optical receiver 219-2 to prevent cross-talk.

As described above, it is possible to efficiently prevent cross-talk in optical signals of adjacent channels by fixing the adjacent channels using injection light in different bands. In other words, even though channels are adjacent to each other, wavelengths of adjacent channels belong to mutually different wavelength bands. Accordingly, even though wavelengths are incompletely aligned in a MUX/de-MUX, it is possible to prevent light of the adjacent channels from being received to receivers by employing bandpass filters.

FIG. 2B illustrates broadband light sources having mutually different bands in a downstream transmission structure of the WDM-PON using an external light-injected light source according to an embodiment of the present invention.

As shown in FIG. 2B, according to an embodiment of the present invention, the light source 112 having a first band and the light source 113 having a second band are separated from each other by a free spectral range (FSR). The first band and the second band include odd channel signals and even channel signals, respectively.

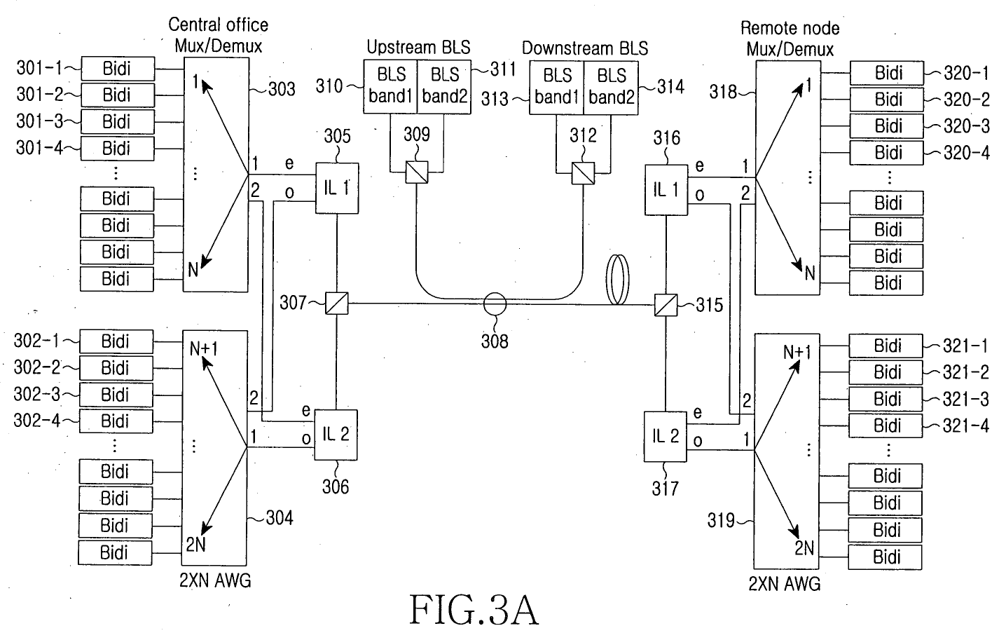

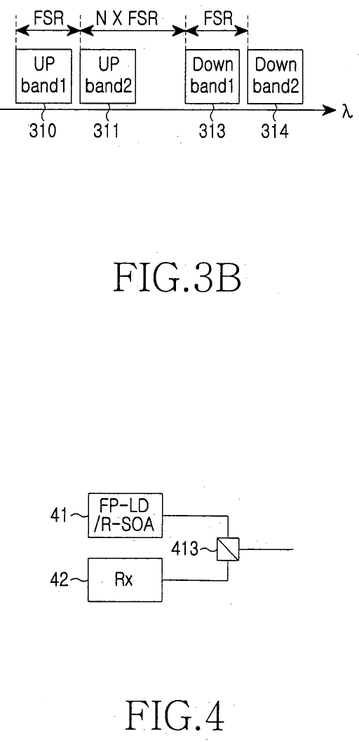

FIG. 3A is a block diagram illustrating an upstream and downstream transmission structure of the WDM-PON using externally light-injected light sources according to an embodiment of the present invention.

The operation of the upstream and downstream transmission structure of the WDM-PON shown in FIG. 3A is identical to those of the upstream transmission structure shown in FIG. 1A and the downstream transmission structure shown in FIG. 2A except that the upstream and the downstream transmission structure of the WDM-PON includes bi-directional transceivers 301-1 to 301-4, 302-1 to 302-4, 320-1 to 320-4, and 321-1 to 321-4, and upstream and downstream injection light is input to a transmission optical fiber using a directional coupler 308 instead of circulators 110 and 208.

According to an embodiment of the present invention, as shown in FIG. 3B, a first broadband light source 310 and a second broadband light source 311 for upstream transmission are separated from each other by a free spectral range (FSR), a first broadband light source 313 and a second broadband light source 314 for downstream transmission are separated from each other by FSR, and upstream and downstream bands are separated from each other by an integer multiple of the FSR.

FIG. 4 is a block diagram illustrating the structure of the bi-directional transceiver shown in FIG. 3A.

As shown in FIG. 4, the bi-directional transceiver shown in FIG. 3A includes a receiver 42 and a light-injected light source 41 and connects the receiver 42 to the light-injected light source 41 by means of a WDM filter 413.

According to the present invention, a bandpass filter is further included at a front side of the receiver in order to prevent cross-talk.

As described above, according to the present invention, a wavelength division multiplexed passive optical network (WDM-PON) is described to effectively prevent cross-talk due to incomplete alignment of wavelength channels in a MUX/DE-MUX between a central office and a remote node.

In addition, according to the present invention, it is unnecessary to align wavelengths in the MUX/de-MUX, and it is possible to make conditions for the wavelength alignment easier to realize an economical WDM-PON.

While the invention has been shown and described with reference to certain preferred embodiments thereof, it will be understood by those skilled in the art that various changes in form and details may be made therein without departing from the spirit and scope of the invention. Consequently, the scope of the invention is not limited to the embodiments described herein, but is to be defined by the appended claims and equivalents thereof.

What is claimed is:

1. A wavelength division multiplexed passive optical network (WDM-PON) employing a light-injected light source, the wavelength division multiplexed passive optical network (WDM-PON) comprising:
at least two broadband light sources having mutually exclusive spectrum bands, which provide injection light to be injected to channel light-injected light sources; and
a transmitter receiving injection light from the broadband light sources, injecting the injection light to odd channel light-injected light sources and even channel light-injected light sources, aligning the odd and even channels such that the odd and even channels belong to different spectrum bands, multiplexing the signal according the respective channels and transmitting the multiplexed signal.

2. The wavelength division multiplexed passive optical network (WDM-PON) as claimed in claim 1, wherein the receiver further comprises:
a first bandpass filter for passing a band of the broadband light source to odd channel receivers among channel receivers for receiving signals according to the respective channels; and
a second bandpass filter for passing a band of the broadband light source to even channel receivers among the channel receivers for receiving the signals according to the respective channels.

3. The wavelength division multiplexed passive optical network (WDM-PON) as claimed in claim 1, wherein the light-injected light source is a light-injected Fabry-Perot laser diode (FP-LD).

4. The wavelength division multiplexed passive optical network (WDM-PON) as claimed in claim 1, wherein the light-injected light source is a wavelength-seeded reflective semiconductor amplifier.

5. The wavelength division multiplexed passive optical network (WDM-PON) as claimed in claim 1, wherein the transmitter is a remote node, and the receiver is a central office.

6. The wavelength division multiplexed passive optical network (WDM-PON) as claimed in claim 1, wherein the transmitter is a central office, and the receiver is a remote node.

7. The wavelength division multiplexed passive optical network (WDM-PON) as claimed in claim 1, wherein, the transmitter comprises:
two interleavers for splitting the injection light into two signals by receiving the injection light having mutually exclusive spectrum bands from the broadband light sources, respectively; and
two multiplexer/de-multiplexer for receiving the two signals and splitting the two signals into odd channels and even channels to be output according to the injection light, respectively.

8. The wavelength division multiplexed passive optical network (WDM-PON) as claimed in claim 1 further comprising:
a receiver for receiving the multiplexed signal transmitted from the transmitter and splitting the multiplexed signal according to the respective channels.

9. The wavelength division multiplexed passive optical network (WDM-PON) as claimed in claim 1, wherein the receiver comprises:
two interleavers for receiving signals, which are fixed by the injection light having mutually exclusive spectrum bands, transmitted from the transmitter and splitting the received signals into two signals; and
two multiplexers/de-multiplexers for receiving the two signals from the two interleavers and splitting the two signals into odd channels and even channels to be output according to the signals.

10. The wavelength division multiplexed passive optical network (WDM-PON) as claimed in claim 1, wherein the broadband light sources are separated from each other by a free spectral range.

11. A method for removing cross-talk in a wavelength division multiplexed passive optical network (WDM-PON) employing a light-injected light source, the method comprising the steps of:
providing at least two broadband light sources having mutually exclusive spectrum bands, which provide injection light to be injected to light-injected channel light sources;
receiving injection light having mutually exclusive spectrum bands from the broadband light sources, injecting the injection light to odd channel light-injected light sources and even channel light-injected light sources, aligning the odd and even channels in such a manner that the odd and even channels belong to different spectrum bands, multiplexing the channels according channels; and
transmitting the multiplexed signal.

12. The method as claimed in claim 11, further comprising the step of:
receiving a transmitted multiplexed signal and splitting the transmitted multiplexed signal according to channels.

13. The method as claimed in claim 10, wherein the step of receiving the transmitted multiplexed signal further comprises a step of performing filtering with respect to the different spectrum bands.
